(19) United States
(12) Patent Application Publication
(10) Pub. No.: US 2020/0201486 A1
(43) Pub. Date: Jun. 25, 2020

(54) TOUCH PANEL AND METHOD OF FABRICATING SAME

(71) Applicant: Wuhan China Star Optoelecronics Semiconductor Display Technology Co., Ltd., Wuhan (CN)

(72) Inventor: Xiaoliang FENG, Wuhan (CN)

(73) Assignee: Wuhan China Star Optoelectronics Semiconductor Display Technology Co., Ltd, Wuhan (CN)

(21) Appl. No.: 16/468,677

(22) PCT Filed: Mar. 1, 2019
(86) PCT No.: PCT/CN2019/076705

§ 371 Date: Jun. 12, 2019

(30) Foreign Application Priority Data
Dec. 19, 2018 (CN) 201811559866.8

(51) Int. Cl. G06F 3/044

(52) U.S. Cl. CPC G06F 3/0448; G06F 2203/04103; G06F 2203/04102; G06F 3/0445

(57) ABSTRACT

The present disclosure discloses a touch panel and a method of fabricating the same, in which a plurality of first electrodes and a plurality of second electrodes located in different layers are sequentially connected in series through via holes to form a touch unit, so that the touch unit of the touch panel is flexible.

### BACKGROUND OF INVENTION

### Field of Invention

The present invention relates to a field of touch technologies, and in particular, to a touch panel and a method of fabricating the same.

### Description of Prior Art

With advent of flexible screen products, display devices and touch devices of display screens have gradually evolved towards a direction of flexibility. In order to meet the requirements of flexible screens for flexible characteristics, touch electrodes are all selected to have a metal mesh structure, and the flexibility and electrical conductivity thereof comply with the requirements of flexible displays. However, due to the opacity of the metal, it is necessary to place a metal wire in a non-display area or make the metal wire very thin when manufacturing the metal mesh. Both methods impose high requirements on the process and equipment, resulting in huge equipment investment, indirectly causing an increase in product costs. Indium tin oxide (ITO) is a common choice for non-flexible screen touch electrodes. However, use of indium tin oxide as a touch electrode has a problem of high brittleness, and indium tin oxide electrodes cannot comply with the flexibility requirements of the flexible screen for the touch electrode.

### SUMMARY OF INVENTION

An object of the present invention is to provide a touch panel and a method of manufacturing the same, wherein the touch unit of the touch panel having good flexibility.

A touch panel is provided, wherein the touch panel includes: a substrate; a plurality of first electrodes formed on the substrate; an insulating layer, wherein the insulating layer is formed on the plurality of the first electrodes and the substrate, the insulating layer is provided with a plurality of via holes, and the via holes are located above the first electrodes; and a plurality of second electrodes formed on the insulating layer, wherein the second electrodes are sequentially connected in series with the first electrodes through the via holes to form a touch unit.

In the touch panel, the touch unit includes a rhombus-shaped electrode

In the touch panel, the first electrodes constituting the rhombus-shaped electrode each have a shape of at least one of a square, a rectangle, a rhombus, a circle, a trapezoid, and a triangle, and the second electrodes constituting the rhombus-shaped electrode each have a shape of at least one of a square, a rectangle, a rhombus, a trapezoid, a circle, and a triangle.

In the touch panel, the rhombus-shaped electrode includes a first rhombus pattern composed of the plurality of the first electrodes and a second rhombus pattern composed of the plurality of the second electrodes, and vertical projections of the via holes on the substrate completely fall within portions of vertical projections of the plurality of the first electrodes constituting the first rhombus pattern and vertical projections of the plurality of the second electrodes constituting the second rhombus pattern on the substrate, which are coincident with the vertical projections of the via holes.

In the touch panel, two adjacent rhombus-shaped electrodes in a same row are electrically connected by a first bridge line, and two adjacent rhombus-shaped electrodes in a same column are electrically connected by a second bridge line.

In the touch panel, the first bridge line and the first electrodes are fabricated in a same process and in a same layer, and the second bridge line and the second electrodes are fabricated in a same process and in a same layer, and wherein opposite ends of the first bridge line are respectively connected to the second electrodes in the two adjacent rhombus-shaped electrodes in the same row through the via holes, to electrically connect the two adjacent rhombus-shaped electrodes in the same row, while opposite ends of the second bridge line are respectively connected to the first electrodes in the two adjacent rhombus-shaped electrodes in the same row through the via holes, to electrically connect the two adjacent rhombus-shaped electrodes in the same column.

In the touch panel, the insulating layer is an organic insulating layer.

In the touch panel, the first electrodes each have a size of 1 to 400,000 square micrometers, and the second electrodes each have a size of 1 to 400,000 square micrometers.

In the touch panel, the first electrodes are made of a metal oxide or a metal, and the second electrodes are also made of a metal oxide or a metal.

In the touch panel, the metal oxide is indium tin oxide.

A method of manufacturing a touch panel is provided, including the steps of: providing a substrate; forming a plurality of first electrodes on the substrate; forming an insulating layer with a plurality of via holes on the plurality of the first electrodes and the substrate, wherein the via holes are disposed above the first electrodes; forming a plurality of second electrodes on the insulating layer, wherein the second electrodes are sequentially connected in series with the first electrodes through the via holes to form a touch unit.

In the method of manufacturing the touch panel, the touch unit includes a rhombus-shaped electrode.

In the method of manufacturing the touch panel, the first electrodes constituting the rhombus-shaped electrode have a shape of at least one of a square, a rectangle, a rhombus, a circle, a trapezoid, and a triangle, and the second electrodes constituting the rhombus-shaped electrode have a shape of at least one of a square, a rectangle, a rhombus, a trapezoid, a circle, and a triangle.

In the method of manufacturing the touch panel, the rhombus-shaped electrode includes a first rhombus pattern composed of the plurality of the first electrodes and a second rhombus pattern composed of the plurality of the second electrodes, and vertical projections of the via holes on the substrate are completely fall within portions of vertical projections of the plurality of the first electrodes constituting the first rhombus pattern and vertical projections of the plurality of the second electrodes constituting the second rhombus pattern on the substrate, which are coincident with the vertical projections of the via holes.

In the method of manufacturing the touch panel, two adjacent rhombus-shaped electrodes in a same row are electrically connected by a first bridge line, and two adjacent rhombus-shaped electrodes in a same column are electrically connected by a second bridge line.

In the method of manufacturing the touch panel, the first bridge line and the first electrodes are fabricated in a same process and in a same layer, and the second bridge line and the second electrodes are fabricated in a same process and in a same layer, and wherein opposite ends of the first bridge line are respectively connected to the second electrodes in the two adjacent rhombus-shaped electrodes in the same row through the via holes, to electrically connect the two adjacent rhombus-shaped electrodes in the same row, while opposite ends of the second bridge line are respectively connected to the first electrodes in the two adjacent rhombus-shaped electrodes in the same row through the via holes, to electrically connect the two adjacent rhombus-shaped electrodes in the same column.

In the method of manufacturing the touch panel, the insulating layer is an organic insulating layer.

In the method of manufacturing the touch panel, the first electrodes each have a size of 1 to 400,000 square micrometers, and the second electrodes each have a size of 1 to 400,000 square micrometers.

In the method of manufacturing the touch panel, the first electrodes are made of a metal oxide or a metal, and the second electrodes are also made of a metal oxide or a metal.

In the method of manufacturing the touch panel, the metal oxide is indium tin oxide.

The present invention provides a touch panel and a method of fabricating the same, in which a plurality of first electrodes and a plurality of second electrodes located in different layers are sequentially connected in series through the via holes to form a touch unit, so that the touch unit of the touch panel is flexible.

### BRIEF DESCRIPTION OF DRAWINGS

FIG. 1 is a schematic diagram of a touch unit on a conventional touch panel.

FIG. 2 is a flowchart of a method for manufacturing a touch panel of a first embodiment of the present invention;

FIGS. 3A-3E are schematic views of a manufacturing process of the touch panel of FIG. 2.

Elements in the drawings are designated by reference numerals listed below:

21 substrate; 22, 23 first electrode; 102 first bridge line; 24 insulation layer; 25 via hole; 26, 27 second electrode; 103 second bridge line; 10 touch unit; 100 transmitting electrode; 101 receiving electrode.

### DETAILED DESCRIPTION OF PREFERRED EMBODIMENTS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

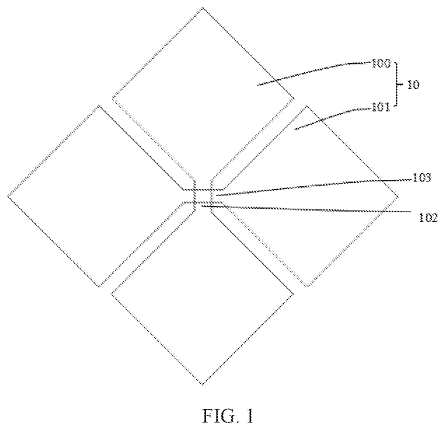

As shown in FIG. 1, which is a schematic diagram of a touch unit 10 on a conventional touch panel. The touch units 10 are double-layered mutual-capacitive touch electrodes, and includes transmitting electrodes 100 and receiving electrodes 101. The transmitting electrodes 100 are rhombus-shaped electrodes, and two adjacent transmitting electrodes 100 are connected by a first bridge line 102. The receiving electrodes 101 are rhombus-shaped electrodes, and two adjacent receiving electrodes 101 are connected by a second bridge line 103, wherein the first bridge line 102 and the second bridge line 103 are connected. An insulating layer (not shown) is provided between the transmitting electrode 100 and the receiving electrode 101 to insulate the transmitting electrode 100 from the receiving electrode 101. When the transmitting electrode 100 and the receiving electrode 101 are made of indium tin oxide or a material that is prone to fracture when it is bent multiple times, the flexibility of the touch unit 10 is poor, and is not suitable for flexible screens.

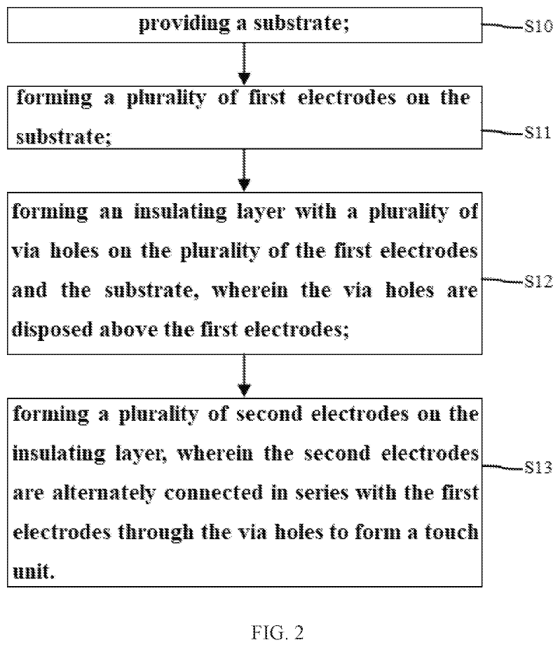

Please refer to FIG. 2, which is a flowchart of a method for manufacturing a touch panel according to a first embodiment of the present invention. The manufacturing method includes the following steps:

S10: providing a substrate 21.

In this embodiment, the substrate 21 may be a flexible substrate or a rigid substrate. The flexible substrate includes, but is not limited to, a polyimide (PI) substrate, a cyclo olefin polymer (COP) substrate, a polyethylene terephthalate (PET) substrate, and a flexible organic light emitting diode (OLED). The rigid substrate includes, but is not limited to, glass substrates, thin film transistor array substrates, liquid crystal panels, and rigid OLEDs.

S11: forming a plurality of first electrodes 22 on the substrate 21.

In this embodiment, an array of the first electrodes 22 is arranged on the substrate 21. The first electrodes 22 may be formed on the substrate 21 by a photolithography process, a screen-printing process, or other processes. The first electrodes 22 may be indium tin oxide electrodes, metal mesh, or other electrodes, that is, the first electrodes 22 are made of a metal oxide, a metal or the like. Shapes of the first electrodes 22 include a square, a rectangle, a rhombus, a trapezoid, a circle, a triangle, or other irregular shapes, which is not specifically limited in the present invention.

To illustrate the technical solution of the present invention, the present invention is illustrated in a context that the first electrodes 22 are square indium tin oxide electrodes, wherein the plurality of array-arranged first electrodes 22 constitute a plurality of first rhombus patterns arranged in a row array and a column array, and the first rhombus pattern arranged in the column array has a size larger than the first rhombus pattern arranged in the row array. A first bridge line 23 is disposed between two adjacent first rhombus patterns arranged in the row array. The first bridge line 23 and the first electrodes 22 are fabricated in a same process and in a same layer.

Specifically, an indium tin oxide (ITO) film layer is formed on the substrate 21 by a sputtering deposition process, and then a photoresist layer is formed on the ITO film layer, followed by exposure through a first mask plate. The exposed photoresist layer is developed by a developer solution to remove a part of the photoresist layer. A remaining photoresist layer covers a part the ITO film layer, and the ITO film layer not covered by the photoresist layer is removed by an etching process, and the plurality of the first electrodes 22 arranged in an array and the first bridge line 23 are formed after removing the remaining photoresist layer. The sizes of the first electrodes 22 are 1-200 μm square, that is, the sizes of the first electrodes 22 are 1-400,000 μm square micrometer. The sizes of the first electrodes 22 can be smaller to improve the bending resistance, and the sizes of the first electrodes 22 are 10-150 μm square, and for example, the first electrodes 22 each have a size of 20 μm square, 50 μm square, 80 μm square or 120 μm square. The small size of the first electrodes 22 is advantageous to prevent the first electrodes 22 from being cracked when it is bent, that is, advantageous to improve the flexibility of the first electrodes 22.

S12: forming an insulating layer 24 with a plurality of via holes 25 on the plurality of the first electrodes 22 and the substrate 21, wherein the via holes 25 are disposed above the first electrodes 22.

Specifically, the insulating layer 24 is formed on an entire surface of the first electrodes 22 and the substrate 21 by one of plasma enhanced chemical vapor deposition (PECVD), chemical vapor deposition (CVD), atom layer deposit (ALD), sputter deposition, vacuum evaporation, inkjet printing, and spin coating.

Then, the plurality of via holes 25 are formed on the insulating layer 24 by a photolithography process. The via holes 25 are located above each of the first electrodes 22. The photolithography process is the same as that in step S11, and details are not repeated herein for brevity.

The number and position of the via holes 25 above each of the first electrodes 22 depend on the shape of the first electrodes 22, the position of the first electrodes 22 in the first rhombus pattern, and the shape of the subsequently formed second electrodes, and so on. For the first rhombus pattern composed of the plurality of the first electrodes 22 formed in step S11, two via holes 25 are respectively disposed above each of the first electrodes 22 at two opposite vertexes of the same first rhombus pattern, wherein two via holes 25 are located at opposite corners of each of the first electrodes 22 respectively, and one of the two via holes 25 is used for connecting with a subsequently formed second bridge line, while the first electrodes 22 at the two opposite vertexes are located between two adjacent first rhombus patterns. One via hole 25 is located on a corner of each the first electrodes 22 at the other two opposite vertexes of the first rhombus pattern. Two via holes 25 are located on each the first electrodes 22 at edges of the first rhombus pattern, and the via holes 25 are located on each of adjacent corners of the first electrodes 22. Four via holes 25 are located on each of the first electrodes 22 inside the first rhombus pattern, and the via holes 25 are respectively located at four corners of each of the first electrodes 22. Sizes of the via holes 25 are smaller than the sizes of the first electrodes 22, which is not specifically limited in the present invention.

In the present embodiment, the insulating layer 24 is an organic insulating layer, an inorganic insulating layer, or a lamination of an organic insulating layer and an inorganic insulating layer. Material for preparing the organic insulating layer includes, but is not limited to, polyimide and polyacrylate. Material for preparing the inorganic insulating layer includes, but is not limited to, silicon nitride, silicon oxide or silicon oxynitride.

S13: forming a plurality of second electrodes 26 on the insulating layer 24, wherein the second electrodes 26 are sequentially connected in series with the first electrodes 22 through the via holes 25 to form a touch unit.

In this embodiment, the touch unit is one of a double-layered mutual-capacitive electrode, a single-layered mutual-capacitive electrode, and a single-layered self-capacitive electrode. Specifically, the touch unit is a double-layered mutual-capacitive electrode.

In the present embodiment, the second electrodes 26 are arranged in an array on the insulating layer 24. The second electrode 26 may be an indium tin oxide electrode, a metal mesh or other electrodes, that is, the second electrode 26 is made of a metal oxide, a metal or other materials. The second electrode 26 may be formed on the insulating layer 24 by a photolithography process, a screen printing process or other processes, and sequentially connected in series with the first electrodes 22 through the via holes 25 to form a touch unit. Shapes of the second electrodes 26 include a square, a rectangle, a rhombus, a circle, a trapezoid, a triangle, or other irregular shapes, which is not specifically limited in the present invention. The shapes of the second electrodes 26 may be the same as or different from the shapes of the first electrodes 22. Material of the second electrodes 26 may be the same as or different from the material of the first electrodes 22.

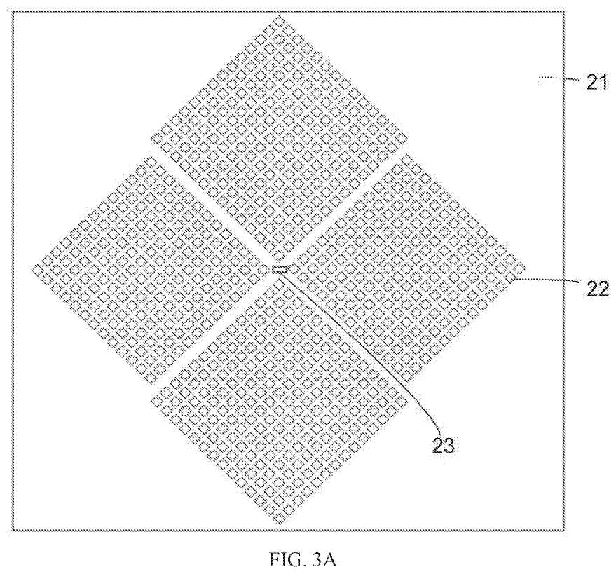

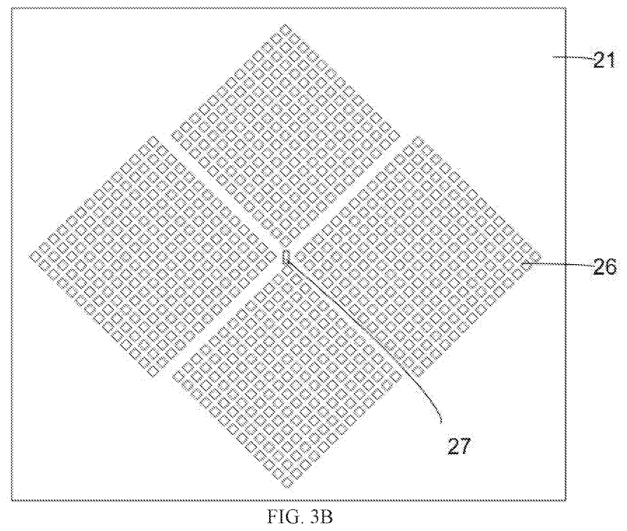

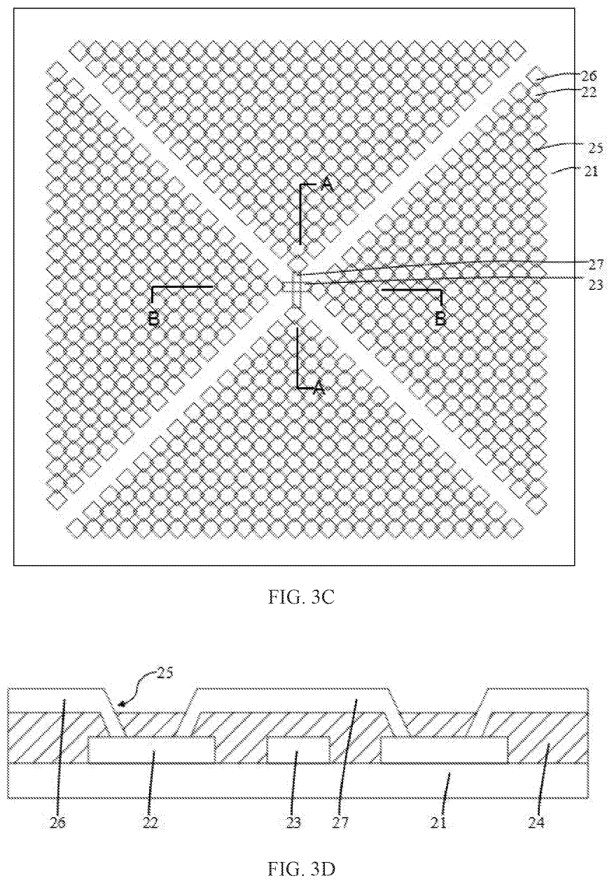

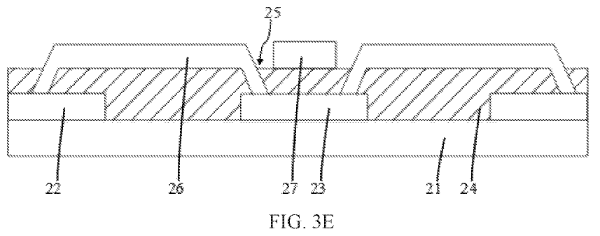

To illustrate the technical solution of the present invention, the second electrode is a square indium tin oxide electrode. Specifically, an ITO film layer is formed on an entire surface of the insulating layer 24, and the ITO film layer is processed by a photolithography process to form the plurality of second electrodes 26 arranged in an array and second bridge lines 27. The plurality of second electrodes 26 form second rhombus patterns arranged in a row array and arranged in a column array, and the size of the second prismatic patterns arranged in the row array are larger than the size of the second prismatic patterns arranged in the column array. The second rhombus patterns arranged in the row array have the same size and same arrangement with the first rhombus patterns arranged in the column array, while the second rhombus patterns arranged in the column array have the same size and same arrangement with the first rhombus patterns arranged in the row array. The second rhombus pattern composed of the plurality of the second electrodes 26 is located above the first rhombus pattern composed of the plurality of the first electrodes 22, and the second bridge line 27 is disposed between the two adjacent second rhombus patterns arranged in the column array, wherein the second bridge line 27 and the second electrodes 26 are formed in the same process and in the same layer, and the second bridge line 27 is located above and perpendicular to the first bridge line 23, as shown in FIG. 3B. The size of the second electrode 26 is 1-200 μm square, that is, the size of the second electrode 26 is 1-400,000 square micrometer, and the size of the second electrode 26 can be smaller to improve the bending resistance. Preferably, the sizes of the second electrodes 26 are 10-150 μm square, and for example, the sizes of the second electrodes 26 are 20 μm square, 50 μm square, 80 μm square or 120 μm square. Small size of the second electrodes 26 is advantageous to prevent the second electrode 26 from cracking when it is bent, that is, to increase the flexibility of the second electrodes 26.

FIG. 3C is a partial schematic view of the first electrodes 22 and the second electrode 26 on the touch panel sequentially connected in series to form a touch unit. As shown in FIG. 3C, the first rhombus pattern composed of the plurality of the first electrodes 22 and the second rhombus pattern composed of the plurality of the second electrodes 26 constitute a plurality of rhombus-shaped electrodes arranged in the row array and arranged in the column array. The rhombus-shaped electrodes constitute a double-layered mutual capacitive touch unit, and vertical projections of the via holes 25 on the substrate 21 completely fall within portions of vertical projections of the plurality of the first electrodes 22 constituting the first rhombus pattern and vertical projections of the plurality of the second electrodes 26 constituting the second rhombus pattern on the substrate 21, which are coincident with the vertical projections of the via holes

As shown in FIGS. 3D and 3E, FIG. 3D is a cross-sectional view taken along a line A-A of FIG. 3C, and FIG. 3E is a cross-sectional view taken along a line B-B of FIG. 3C. Opposite ends of the first bridge line 23 are respectively connected to the second electrodes 26 in the two adjacent rhombus-shaped electrodes in the same row through the via holes 25, to electrically connect the two adjacent rhombus-shaped electrodes in the same row, while opposite ends of the second bridge line 27 are respectively connected to the first electrodes 22 in the two adjacent rhombus-shaped electrodes in the same row through the via holes 25 to electrically connect the two adjacent rhombus-shaped electrodes in the same column.

When the touch panel composed of the touch units is applied to the flexible screen, the interaction force between the first electrodes 22 and the second electrodes 26 that are sequentially connected in series is small, and the stress generated by the bending of the touch units is dispersed to the plurality of the first electrodes 22 and the plurality of the second electrodes 26, wherein the sizes of the first electrodes 22 and the second electrode 26 are significantly reduced with respect to the sizes of the receiving electrodes 100 and the transmitting electrodes 101 constituting a conventional touch unit. Therefore, the first electrode 22 and the second electrode 26 are increased in bending resistance, such that the touch units composed of the first electrodes 22 and the second electrode 26 are flexible to prevent cracks during the bending process.

In the above solution, the plurality of the first electrodes and the plurality of the second electrodes of small size, located in different layers, are sequentially connected in series to form the touch units, so that the touch units constituting the touch panel have flexibility.

The present invention also provides a touch panel manufactured by the above manufacturing method, and the touch panel includes: a substrate; a plurality of first electrodes formed on the substrate; an insulating layer, wherein the insulating layer is formed on the plurality of the first electrodes and the substrate, the insulating layer is provided with a plurality of via holes, and the via holes are located above the first electrodes; and a plurality of second electrodes formed on the insulating layer, wherein the second electrodes are sequentially connected in series with the first electrodes through the via holes to form a touch unit.

In this embodiment, the touch unit includes the rhombus-shaped electrodes, and the rhombus-shaped electrodes are arranged in rows and columns of an array. In other embodiments, the touch unit may also be a square electrode, a rectangular electrode, or an electrode of other shapes.

In this embodiment, the first electrodes constituting the rhombus-shaped electrode each have a shape of at least one of a square, a rectangle, a prism, a circle, a trapezoid, and a triangle, and the second electrodes constituting the rhombus-shaped electrode each have a shape of at least one of a square, a rectangle, a prism, a trapezoid, a circle, and a triangle.

In this embodiment, the rhombus-shaped electrode includes a first rhombus pattern composed of the plurality of the first electrodes and a second rhombus pattern composed of the plurality of the second electrodes, and vertical projections of the via holes on the substrate completely fall within portions of vertical projections of the plurality of the first electrodes constituting the first rhombus pattern and vertical projections of the plurality of the second electrodes constituting the second rhombus pattern on the substrate, which are coincident with the vertical projections of the via holes. The first rhombus patterns composed of the plurality of the first electrodes are arranged in rows and columns of an array, and the second rhombus patterns composed of the plurality of the second electrodes are arranged in rows and columns of an array, and the second rhombus patterns are located directly above the first rhombus patterns.

In this embodiment, two adjacent rhombus-shaped electrodes in a same row are electrically connected by the first bridge line, and two adjacent rhombus-shaped electrodes in a same column are electrically connected by the second bridge line.

In this embodiment, the first bridge line and the first electrodes are fabricated in a same process and in a same layer, and the second bridge line and the second electrodes are fabricated in a same process and in a same layer, and wherein opposite ends of the first bridge line are respectively connected to the second electrodes in the two adjacent rhombus-shaped electrodes in the same row through the via holes, to electrically connect the two adjacent rhombus-shaped electrodes in the same row, while opposite ends of the second bridge line are respectively connected to the first electrodes in the two adjacent rhombus-shaped electrodes in the same row through the via holes to electrically connect the two adjacent rhombus-shaped electrodes in the same column.

In this embodiment, when the first electrodes has the shape of square and the second electrode has the shape of square, two via holes are located on each the first electrode at edges of the first rhombus patterns and between two vertexes of the two adjacent first rhombus patterns, and four via holes are located on each of the first electrodes inside the first rhombus pattern, and one via hole is located on a corner of each the first electrodes at the other vertexes of the first rhombus pattern.

In this embodiment, the first electrodes are made of a metal oxide or a metal, and the second electrode is made of a metal oxide or a metal, wherein the metal oxide may be indium tin oxide. The first electrodes and the second electrodes are small in size, and the touch units are made flexible by sequentially connecting in series the first electrodes and the second electrodes of small sizes in different layers.

In this embodiment, the sizes of the first electrodes are 1-200 μm, and the size of the first electrodes can be smaller to improve bending resistance. Preferably, the sizes of the first electrode are 10-150 μm square, and for example, the first electrodes each have a size of 20 μm square, 50 μm square, 80 μm square or 120 μsquare. The sizes of the second electrodes are 1-200 μm square, and sizes of the second electrodes can be smaller to improve bending resistance, and the size of the second electrode can be smaller to improve the bending resistance. Preferably, the size of the second electrode is 10-150 μm square, and for example, the size of the second electrode is 20 μm square, 50 μm square, 80 μm square or 120 μm square.

In this embodiment, the insulating layer is an organic insulating layer, an inorganic insulating layer, or a lamination of an organic insulating layer and an inorganic insulating layer. Material for preparing the organic insulating layer includes, but is not limited to, polyimide and polyacrylate. Material for preparing the inorganic insulating layer includes, but is not limited to, silicon nitride, silicon oxide or silicon oxynitride.

When the insulating layer is an organic insulating layer, the organic insulating layer isolates the first electrodes and the second electrode, and the foldability of the first electrodes and the second electrode is further improved when the touch panel is applied to the flexible screen. That is, the flexibility of the touch unit composed of the first electrodes and the second electrodes is further improved.

The insulating layer is composed of two organic insulating layers and an inorganic insulating layer between the two intermediate layers. On the one hand, the insulation between the first electrodes and the second electrode is further improved, and on the other hand, the flexibility of the touch unit composed of the first electrodes and the second electrodes is further improved.

In this embodiment, the touch panel further includes a second insulating layer, and the second insulating layer is formed on the plurality of the second electrodes. The second insulating layer is an organic insulating layer, an inorganic insulating layer, or a lamination of an organic insulating layer and an inorganic insulating layer. Material for preparing the organic insulating layer includes, but is not limited to, polyimide or polyacrylate. Material for preparing the inorganic insulating layer includes, but is not limited to, silicon nitride, silicon oxide or silicon oxynitride. In order to further improve the flexibility of the touch unit, the second insulating layer is an organic insulating layer.

The touch panel is formed by sequentially connecting a plurality of first electrodes and a plurality of second electrodes of small sizes in different layers in series to form the touch unit, so that the touch unit constituting the touch panel has flexibility. In addition, because the plurality of the first electrodes and the plurality of the second electrodes located in different layers are sequentially connected in series to form the touch unit, the thickness and the area of the touch unit are increased, thereby reducing the resistance of the touch unit and improving sensitivity of a touch signal, thus helping to reduce the touch control energy consumption. The plurality of the first electrodes and the plurality of the second electrodes are formed in different layers, and spaced apart by the insulating layer therebetween, such that the insulation effect is better, without causing a short circuit of the electrodes, thereby improving process stability and reducing manufacture difficulty.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A touch panel, wherein the touch panel comprises:
a substrate;
a plurality of first electrodes formed on the substrate;
an insulating layer, wherein the insulating layer is formed on the plurality of the first electrodes and the substrate, the insulating layer is provided with a plurality of via holes, and the via holes are located above the first electrodes; and
a plurality of second electrodes formed on the insulating layer, wherein the second electrodes are sequentially connected in series with the first electrodes through the via holes to form a touch unit.

2. The touch panel of claim 1, wherein the touch unit comprises a rhombus-shaped electrode.

3. The touch panel of claim 2, wherein the first electrodes constituting the rhombus-shaped electrode each have a shape of at least one of a square, a rectangle, a prism, a circle, a trapezoid, and a triangle, and the second electrodes constituting the rhombus-shaped electrode each have a shape of at least one of a square, a rectangle, a prism, a trapezoid, a circle, and a triangle.

4. The touch panel of claim 3, wherein the rhombus-shaped electrode comprises a first rhombus pattern composed of the plurality of the first electrodes and a second rhombus pattern composed of the plurality of the second electrodes, and vertical projections of the via holes on the substrate completely fall within portions of vertical projections of the plurality of the first electrodes constituting the first rhombus pattern and vertical projections of the plurality of the second electrodes constituting the second rhombus pattern on the substrate, which are coincident with the vertical projections of the via holes.

5. The touch panel of claim 2, wherein two adjacent rhombus-shaped electrodes in a same row are electrically connected by a first bridge line, and two adjacent rhombus-shaped electrodes in a same column are electrically connected by a second bridge line.

6. The touch panel of claim 5, wherein the first bridge line and the first electrodes are fabricated in a same process and in a same layer, and the second bridge line and the second electrodes are fabricated in a same process and in a same layer, and wherein opposite ends of the first bridge line are respectively connected to the second electrodes in the two adjacent rhombus-shaped electrodes in the same row through the via holes, to electrically connect the two adjacent rhombus-shaped electrodes in the same row, while opposite ends of the second bridge line are respectively connected to the first electrodes in the two adjacent rhombus-shaped electrodes in the same row through the via holes to electrically connect the two adjacent rhombus-shaped electrodes in the same column.

7. The touch panel of claim 1, wherein the insulating layer is an organic insulating layer.

8. The touch panel of claim 1, wherein the first electrodes each have a size of 1 to 400,000 square micrometers, and the second electrodes each have a size of 1 to 400,000 square micrometers.

9. The touch panel of claim 1, wherein the first electrodes are made of a metal oxide or a metal, and the second electrodes are also made of a metal oxide or a metal.

10. The touch panel of claim 9, wherein the metal oxide is indium tin oxide.

11. A method of manufacturing a touch panel, comprising the steps of:
providing a substrate;
forming a plurality of first electrodes on the substrate;
forming an insulating layer with a plurality of via holes on the plurality of the first electrodes and the substrate, wherein the via holes are disposed above the first electrodes;
forming a plurality of second electrodes on the insulating layer, wherein the second electrodes are alternately connected in series with the first electrodes through the via holes to form a touch unit.

12. The method of manufacturing the touch panel of claim 11, wherein the touch unit comprises a rhombus-shaped electrode.

13. The method of manufacturing the touch panel of claim 12, wherein the first electrodes constituting the rhombus-shaped electrode have a shape of at least one of a square, a rectangle, a prism, a circle, a trapezoid, and a triangle, and the second electrodes constituting the rhombus-shaped electrode have a shape of at least one of a square, a rectangle, a prism, a trapezoid, a circle, and a triangle.

14. The method of manufacturing the touch panel of claim 13, wherein the rhombus-shaped electrode comprises a first rhombus pattern composed of the plurality of the first electrodes and a second rhombus pattern composed of the plurality of the second electrodes, and vertical projections of the via holes on the substrate are completely fall within portions of vertical projections of the plurality of the first electrodes constituting the first rhombus pattern and vertical projections of the plurality of the second electrodes constituting the second rhombus pattern on the substrate, which are coincident with the vertical projections of the via holes.

15. The method of manufacturing the touch panel of claim 12, wherein two adjacent rhombus-shaped electrodes in a same row are electrically connected by a first bridge line, and two adjacent rhombus-shaped electrodes in a same column are electrically connected by a second bridge line.

16. The method of manufacturing the touch panel of claim 15, wherein the first bridge line and the first electrodes are fabricated in a same process and in a same layer, and the second bridge line and the second electrodes are fabricated in a same process and in a same layer, and wherein opposite ends of the first bridge line are respectively connected to the second electrodes in the two adjacent rhombus-shaped electrodes in the same row through the via holes to electrically connect the two adjacent rhombus-shaped electrodes in the same row, while opposite ends of the second bridge line are respectively connected to the first electrodes in the two adjacent rhombus-shaped electrodes in the same row through the via holes to electrically connect the two adjacent rhombus-shaped electrodes in the same column.

17. The method of manufacturing the touch panel of claim 11, wherein the insulating layer is an organic insulating layer.

18. The method of manufacturing the touch panel of claim 11, wherein the first electrodes each have a size of 1 to 400,000 square micrometers, and the second electrodes each have a size of 1 to 400,000 square micrometers.

19. The method of manufacturing the touch panel of claim 11, wherein the first electrodes are made of a metal oxide or a metal, and the second electrodes are also made of a metal oxide or a metal.

20. The method of manufacturing the touch panel of claim 19, wherein the metal oxide is indium tin oxide.
